(19) United States
(12) Patent Application Publication
(10) Pub. No.: US 2026/0001414 A1
(43) Pub. Date: Jan. 1, 2026

(54) VEHICLE

(71) Applicant: SUBARU CORPORATION, Tokyo (JP)

(72) Inventors: Shunichi NAKAMURA, Tokyo (JP); Tomoyuki KITAMURA, Tokyo (JP); Takumi TAKADA, Tokyo (JP); Hiroaki KUDO, Tokyo (JP); Yosuke KANEKO, Tokyo (JP); Keita NAKAHASHI, Tokyo (JP); Kei FUJI, Tokyo (JP)

(21) Appl. No.: 19/228,879

(22) Filed: Jun. 5, 2025

(30) Foreign Application Priority Data
Jun. 26, 2024 (JP) 2024-103224

(51) Int. Cl. B60L 50/60; B60L 7/16; B60L 15/20; B60L 58/12; B60L 58/20

(52) U.S. Cl. CPC B60L 50/60; B60L 7/16; B60L 15/20; B60L 58/12; B60L 58/20; B60L 2210/14; B60L 2210/40; B60L 2240/423

(57) ABSTRACT

A vehicle includes: a motor; a first battery; auxiliary equipment; a battery mounting member; a voltage booster; at least one processor; and a storage medium that stores a program to be executed by the at least one processor. When a second battery is mounted on the battery mounting member, second battery supplies power to the auxiliary equipment and also to the first battery via the voltage booster. The program includes at least one command that causes the at least one processor to execute power supply control processing. In the power supply control processing, when a charging rate of the first battery becomes lower than or equal to a predetermined value, power consumption in the auxiliary equipment is estimated, and power supply from the second battery to the first battery is started at least on condition that a value of the estimated power consumption is smaller than a threshold.

### CROSS-REFERENCE TO RELATED APPLICATIONS

The present application claims priority from Japanese Patent Application No. 2024-103224 filed on Jun. 26, 2024, the entire contents of which are hereby incorporated by reference.

### BACKGROUND

The disclosure relates to a vehicle that serves as an electrified vehicle including a motor provided as a drive source for the wheels of the vehicle, and more particularly, to a technical field related to power supply control for a battery provided as a power supply source for a motor.

As an example of a technology for performing power supply control for a battery in an electrified vehicle, the following technology is disclosed in Japanese Unexamined Patent Application Publication (JP-A) No. 2012-244875 and JP-A No. 2009-154847. The output voltage of a low-voltage battery used for auxiliary equipment is boosted and electric power is supplied to a high-voltage battery used for driving a motor. In particular, JP-A No. 2012-244875 discloses a technology for supplying electric power from the low-voltage battery to the high-voltage battery in response to the state of charge (SOC) of the high-voltage battery becoming lower than a lower limit value.

### SUMMARY

An aspect of the disclosure provides a vehicle including a motor, a first battery, auxiliary equipment, a battery mounting member, a voltage booster, at least one processor, and a storage medium. The motor is provided as a drive source for a wheel. The first battery is provided as a power supply source for the motor. The battery mounting member is configured to removably mount a second battery on the battery mounting member. A rated output voltage of the second battery is lower than a rated output voltage of the first battery. The voltage booster is configured to boost an output voltage of the second battery. The storage medium is configured to store a program to be executed by the at least one processor. The second battery is configured to, when the second battery is mounted on the battery mounting member, supply power to the auxiliary equipment and also supply power to the first battery via the voltage booster. The program includes at least one command that causes the at least one processor to execute power supply control processing. In the power supply control processing, when a charging rate of the first battery becomes lower than or equal to a predetermined value, power consumption in the auxiliary equipment is estimated, and power supply from the second battery to the first battery is started at least on condition that a value of the estimated power consumption is smaller than a threshold.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates an example of the schematic internal configuration of a vehicle according to an embodiment;

FIG. 2 illustrates an example of the electrical configuration of the embodiment regarding power supply control;

FIG. 3 is a flowchart illustrating processing executed by monitoring the state of charge (SOC) of a first battery; and

FIG. 4 is a flowchart illustrating processing executed by monitoring the intended torque.

### DETAILED DESCRIPTION

It is desirable to improve the use of a power supply system in a vehicle that serves as an electrified vehicle including a motor provided as a drive source for the wheels of the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

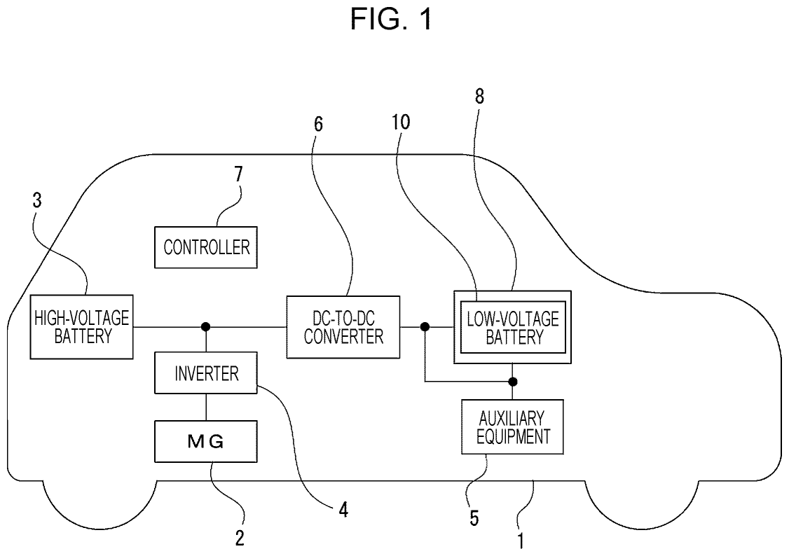

FIG. 1 illustrates an example of the schematic internal configuration of a vehicle 1 according to the embodiment.

Among the components of the vehicle 1 of the embodiment, the components only related to the technology of the disclosure are illustrated in FIG. 1.

The vehicle 1 of the embodiment is formed as an electrified vehicle including a motor generator (MG) 2 provided as a drive source for the wheels. In one example, the vehicle 1 of the example in FIG. 1 is formed as a battery electric vehicle (BEV) without having any engine as a drive source for the wheels.

In this example, the vehicle 1 is assumed as a four-wheeled vehicle. However, the vehicle 1 of the embodiment may be an electrified vehicle having at least two or more wheels.

The vehicle 1 includes a high-voltage battery 3 provided as a power supply source for the MG 2 and also includes an inverter 4 for the MG 2. When the MG 2 is in the power running mode, the inverter 4 outputs a drive voltage, which is generated based on the input voltage from the high-voltage battery 3, to the MG 2. When the MG 2 is in the regenerative running mode, the inverter 4 charges the high-voltage battery 3 by using regenerative power generated by the MG 2.

The rated output voltage of the high-voltage battery 3 is as high as 200 V or 400 V, for example.

The vehicle 1 also includes auxiliary equipment 5. The auxiliary equipment 5 includes a wide variety of in-vehicle electronic devices, such as various electronic control units (ECUs) used for controlling various operations of the vehicle 1, meters, a navigation device, audio equipment, an air conditioner, a seat heater, and lights, such as a headlight.

Examples of the ECUs installed in the vehicle 1 are a running control ECU, a stability control ECU, a door ECU, a lighting ECU, an air-conditioner ECU, and a navigation ECU. The running control ECU performs control regarding output torque and regenerative force of the MG 2 in accordance with an accelerating operation or a braking operation performed by a driver who is driving the vehicle 1. The stability control ECU performs control regarding the running stability of the vehicle 1, such as anti-lock braking system (ABS) control and electronic stability control (ESC). The door ECU performs control to lock and unlock the doors. The lighting ECU performs control for lights, such as a headlamp and a turn signal lamp. The air-conditioner ECU performs control for the air conditioner. The navigation ECU performs control for navigation.

Basically, the vehicle 1 of the embodiment supplies electric power to the auxiliary equipment 5 by using the high-voltage battery 3 as a power supply source. For example, the vehicle 1 includes a DC-to-DC converter 6 having a voltage reducing function, and can reduce the voltage of the output voltage of the high-voltage battery 3 by using this voltage reducing function and then supply electric power to the auxiliary equipment 5.

In this example, the rated input voltage of the auxiliary equipment 5 is about 12 V, and the DC-to-DC converter 6 reduces the output voltage of the high-voltage battery 3 to about 12 V and outputs the reduced output voltage to the auxiliary equipment 5.

The rated input voltage of the auxiliary equipment 5 is not limited to about 12 V and may be about 24 V, for example.

A controller 7 is constituted by a microcomputer including a central processing unit (CPU), a read only memory (ROM), and a random access memory (RAM). The controller 7 performs various types of control for the vehicle 1 as a result of the CPU executing various processing operations in accordance with a program stored in the ROM.

In this example, the controller 7 is constituted by any of the in-vehicle ECUs and thus corresponds to one type of auxiliary equipment 5.

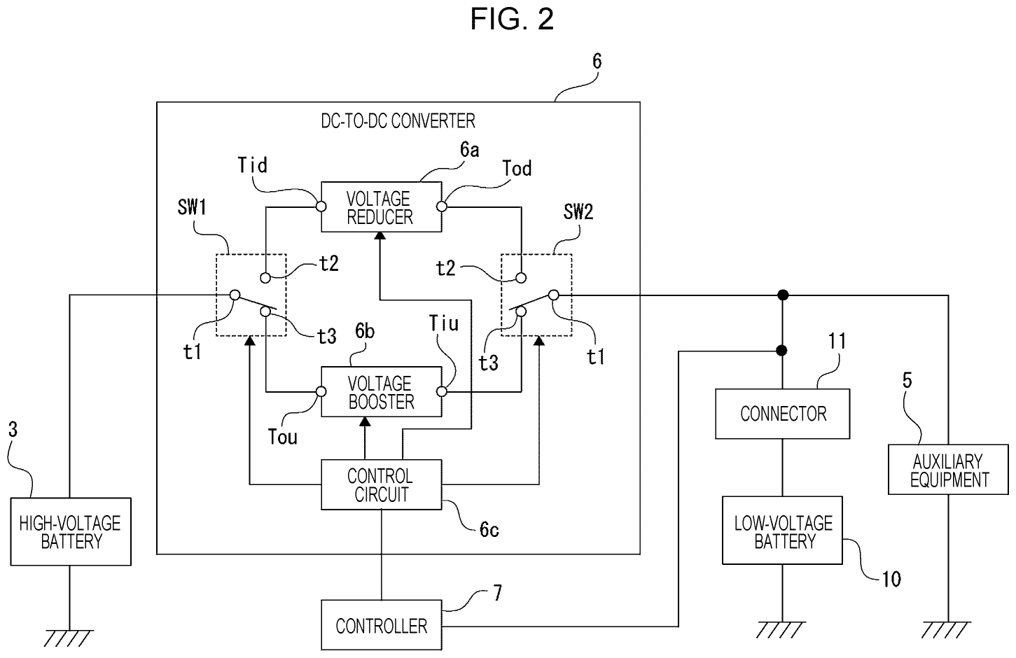

In FIGS. 1 and 2, the auxiliary equipment 5 and the controller 7 are separately illustrated for the sake of representation.

The vehicle 1 of the embodiment includes a battery mounting member 8. A low-voltage battery 10 can be removably mounted on the battery mounting member 8. The rated output voltage of the low-voltage battery 10 is lower than that of the high-voltage battery 3.

In the embodiment, the low-voltage battery 10 is provided to extend the drivable distance of the vehicle 1. As the low-voltage battery 10, a battery that can be attached to the vehicle 1 by a user of the vehicle 1, such as a driver, at a desirable timing is assumed.

For this purpose, the structure of the battery mounting member 8 is simply configured so that the low-voltage battery 10 can be relatively easily mounted on the battery mounting member 8. For example, the low-voltage battery 10 can be attached, not by a method using tools, such as screwing, but by a method using a fastening mechanism, such as a buckle, without using tools.

In the vehicle 1 of the embodiment, when the low-voltage battery 10 is mounted on the battery mounting member 8, electric power can be supplied from the low-voltage battery 10 to the high-voltage battery 3. For instance, in the vehicle 1 of this example, the DC-to-DC converter 6 has a voltage boost function as well as the above-described voltage reducing function. When the low-voltage battery 10 is mounted on the battery mounting member 8, the output voltage of the low-voltage battery 10 can be boosted by this voltage boost function, and electric power can be supplied to the high-voltage battery 3 using the boosted voltage.

In the vehicle 1 of the embodiment, when the low-voltage battery 10 is mounted on the battery mounting member 8, power supply from the high-voltage battery 3 to the auxiliary equipment 5 via the DC-to-DC converter 6 is stopped, and power supply from the low-voltage battery 10 to the auxiliary equipment 5 is started.

The rated output voltage of the low-voltage battery 10 is substantially equal to the rated input voltage of the auxiliary equipment 5, and they are about 12 V in this example.

In the vehicle 1 of the embodiment, electric power can be supplied from the high-voltage battery 3 to the auxiliary equipment 5. This enables the vehicle 1 to run even without the low-voltage battery 10.

In the vehicle 1 of the embodiment, the low-voltage battery 10 can be optionally attached to the vehicle 1. This can extend the drivable distance of the vehicle 1 even in a situation where the vehicle 1 is unable to receive power from a power supply device outside the vehicle 1, for example, when a power supply facility is not available nearby.

In the vehicle 1 of the embodiment, when the low-voltage battery 10 is mounted on the battery mounting member 8, power supply from the high-voltage battery 3 to the auxiliary equipment 5 is stopped, and power supply from the low-voltage battery 10 to the auxiliary equipment 5 is started. This can prevent the occurrence of conversion loss. The conversion loss is the electric power loss that occurs when the output voltage of the high-voltage battery 3 is reduced by the DC-to-DC converter 6. Preventing the occurrence of conversion loss can increase the efficiency in power supply to the auxiliary equipment 5.

FIG. 2 illustrates an example of the electrical configuration of the embodiment regarding power supply control.

In one example, in FIG. 2, an example of the internal configuration of the DC-to-DC converter 6 and a connector 11 for electrically connecting the low-voltage battery 10 to the vehicle 1 are illustrated, as well as the high-voltage battery 3, auxiliary equipment 5, controller 7, and low-voltage battery 10 illustrated in FIG. 1.

As illustrated in FIG. 2, the DC-to-DC converter 6 includes a voltage reducer 6a, a voltage booster 6b, a first switch SW1, and a second switch SW2, as well as a control circuit 6c.

The voltage reducer 6a reduces the input voltage input into an input terminal Tid and outputs the reduced voltage from an output terminal Tod.

The voltage booster 6b boosts the input voltage input into an input terminal Tiu and outputs the boosted voltage from an output terminal Tou.

Each of the first and second switches SW1 and SW2 is formed as a three-terminal switch having a first terminal t1, a second terminal t2, and a third terminal t3. The first terminal t1 is selectively coupled to one of the second terminal t2 and the third terminal t3.

In the first switch SW1, the first terminal t1 is coupled to the high-voltage battery 3, the second terminal t2 is coupled to the input terminal Tid of the voltage reducer 6a, and the third terminal t3 is coupled to the output terminal Tou of the voltage booster 6b.

In the second switch SW2, the first terminal t1 is coupled to a node between the auxiliary equipment 5 and the connector 11, the second terminal t2 is coupled to the output terminal Tod of the voltage reducer 6a, and the third terminal t3 is coupled to the input terminal Tiu of the voltage booster 6b.

When the second terminal t2 is selected in each of the first and second switches SW1 and SW2, the output voltage of the high-voltage battery 3 can be reduced in the voltage reducer 6a and the reduced voltage can be supplied to the node between the auxiliary equipment 5 and the connector 11.

When the third terminal t3 is selected in each of the first and second switches SW1 and SW2, the output voltage of the low-voltage battery 10 can be boosted in the voltage booster 6b and the boosted voltage can be supplied to the high-voltage battery 3.

The control circuit 6c includes an integrated circuit (IC), for example, and controls the operations of the voltage reducer 6a and the voltage booster 6b and also controls the first and second switches SW1 and SW2.

As terminals for the connector 11, the connector 11 at least includes a positive terminal and a negative terminal for power supply. The low-voltage battery 10 may include a storage, such as a lithium ion battery unit or a battery cell, and a microcomputer that executes various processing operations regarding charging/discharging of the storage. In this case, a signal terminal for sending and receiving various signals is also provided in the connector 11, together with the above-described positive and negative terminals.

The connector 11 includes a connector provided in the vehicle 1 and a connector provided in the low-voltage battery 10, and by connecting these connectors to each other, the low-voltage battery 10 and the vehicle 1 can be electrically connected to each other.

In the specification, “mounting” or “attaching” of the low-voltage battery 10 includes the meaning of mounting or attaching of these connectors, in other words, the meaning of electrical connection of these connectors.

The controller 7 performs control regarding power supply to the auxiliary equipment 5 and power supply to the high-voltage battery 3.

For example, when the state of charge (SOC), that is, the charging rate, of the high-voltage battery 3 becomes lower than or equal to a predetermined value, which will be hereinafter called a threshold THh, the controller 7 executes the following power supply control processing. The controller 7 performs control to estimate power consumption in the auxiliary equipment 5 and to start power supply from the low-voltage battery 10 to the high-voltage battery 3 at least on condition that the value of the power consumption in the auxiliary equipment 5 is lower than a threshold THu.

The power consumption in the auxiliary equipment 5 may be estimated from the total value of the current consumption of the individual loads belonging to the auxiliary equipment 5, such as various ECUs, the air-conditioner, and the seat heater. The total value of the current consumption can be detected as the output current value of the low-voltage battery 10. In one embodiment, the low-voltage battery 10 may serve as a second battery.

As a result of the controller 7 executing the above-described power supply control processing, when the power consumption in the auxiliary equipment 5 is higher than or equal to the threshold THu, that is, if intended power for the auxiliary equipment 5 is high, power supply from the low-voltage battery 10 to the high-voltage battery 3 is not performed. This can prevent the auxiliary equipment 5 from suffering from power shortage and thereby prevent the vehicle 1 from being unable to run.

If the intended torque of the MG 2 becomes higher than or equal to a predetermined value, which will be hereinafter called a threshold THt, the controller 7 also executes the above-described power supply control processing. That is, the controller 7 performs control to estimate power consumption in the auxiliary equipment 5 and to start power supply from the low-voltage battery 10 to the high-voltage battery 3 at least on condition that the value of the power consumption in the auxiliary equipment 5 is lower than the threshold THu.

In one example, even when the SOC of the high-voltage battery 3 is higher than the threshold THh, if the intended torque of the MG 2 becomes higher than or equal to the threshold THt, the controller 7 executes power supply control processing to supply power from the low-voltage battery 10 to the high-voltage battery 3 on condition that the value of the power consumption in the auxiliary equipment 5 is lower than the threshold THu.

With this operation, when the output of the MG 2 (output of a motor) is predicted to be high, power supply from the low-voltage battery 10 to the high-voltage battery 3 can be performed.

This can prevent the MG 2 from being short of driving force and thereby prevent the degradation of the acceleration performance of the vehicle 1.

The intended torque represents the intended value of the output torque of the MG 2, and the above-described running control ECU calculates the intended torque in accordance with the accelerating operation.

In the embodiment, power supply from the low-voltage battery 10 to the high-voltage battery 3 is not performed if the power consumption in the auxiliary equipment 5 is higher than or equal to the threshold THu, as described above. Additionally, if the connection state of the connector 11 is loose, power supply from the low-voltage battery 10 to the high-voltage battery 3 is not performed, either, even if the SOC of the high-voltage battery 3 becomes lower than or equal to the threshold THh or the intended torque becomes higher than or equal to the threshold THt.

To satisfy the above-described conditions, in this example, in each of the case in which the SOC of the high-voltage battery 3 becomes lower than or equal to the threshold THh and the case in which the intended torque becomes higher than or equal to the threshold THt, the controller 7 determines whether the power consumption of the auxiliary equipment 5 is higher than or equal to the threshold THu and whether the connector 11 is loosely connected. If the power consumption of the auxiliary equipment 5 is lower than the threshold THu and if the connector 11 is not loosely connected but is securely connected, the controller 7 performs control to start power supply from the low-voltage battery 10 to the high-voltage battery 3.

The connection state of the connector 11 may be detected based on the voltage across the positive terminal and the negative terminal of the connector 11 or the fluctuation (amount of change per unit time) of a current flowing through the positive terminal. For instance, if the fluctuation of a current exceeds a predetermined level and the occurrence of the fluctuation is frequent in excess of a predetermined threshold, it may be determined that the connector 11 is loosely connected.

Alternatively, if the connector 11 includes the above-described signal terminal for performing communication, the connection state of the connector 11 may be determined, based on whether and how frequent communication is interrupted, for example.

When the connection state of the connector 11 is loose, electric arc may occur between the terminal of the low-voltage battery 10 and the terminal of the body of the vehicle 1. In particular, the voltage is boosted when supplying power from the low-voltage battery 10 to the high-voltage battery 3, and the occurrence of electric arc may lead to an accident, such as catching fire.

As described above, when the connector 11 is loosely connected, power supply from the low-voltage battery 10 to the high-voltage battery 3 is not performed. Hence, electric arc does not occur, the safety is thus improved.

In this example, if it is determined in a certain driving cycle that the connector 11 is loosely connected, the controller 7 maintains a state in which power supply from the low-voltage battery 10 to the high-voltage battery 3 is stopped during this driving cycle. In other words, if it is determined in a certain driving cycle that the connector 11 is loosely connected, power supply from the low-voltage battery 10 to the high-voltage battery 3 is prohibited until the end of this driving cycle.

The driving cycle is a unit of one driving operation. The period of time from when a driver gets in a vehicle until when the driver finishes driving is set to be one driving cycle. The start time of one driving cycle may be a timing at which the start button (ON button) of the vehicle 1 is operated or a timing at which the state of a door is changed from the locking state to the unlocking state, for example. The end time of one driving cycle may be a timing at which the start button is reoperated while the vehicle 1 is in operation or a timing at which the door is locked after the start button is reoperated, for example.

In this manner, power supply from the low-voltage battery 10 to the high-voltage battery 3 is prohibited until the end of a driving cycle. Power is not supplied from the low-voltage battery 10 to the high-voltage battery 3 until the connector 11 seems ready to be reconnected. After the connector 11 is reconnected, power supply from the low-voltage battery 10 to the high-voltage battery 3 can be started.

It is thus possible to improve the safety, as well as to extend the drivable distance of the vehicle 1 and to assist the high-voltage battery 3 in driving the motor by supplying power from the low-voltage battery 10 to the high-voltage battery 3.

In the above-described example, the power consumption in the auxiliary equipment 5 is estimated from the total value of the current consumption of the individual loads belonging to the auxiliary equipment 5. Alternatively, the power consumption in the auxiliary equipment 5 may be estimated based on loads only consuming a large amount of electric power, such as an air-conditioner, a seat heater, an electric pump for circulating a lubricant in a drive system.

When a load consuming a large amount of electric power is predicted to be used, power supply from the low-voltage battery 10 to the high-voltage battery 3 may be prohibited. In one example, when the air conditioner or the seat heater is likely to be used based on outside temperature information, power supply from the low-voltage battery 10 to the high-voltage battery 3 may not be performed. In another example, when an external device is coupled to a 100V AC outlet provided in a vehicle, power supply from the low-voltage battery 10 to the high-voltage battery 3 may not be performed.

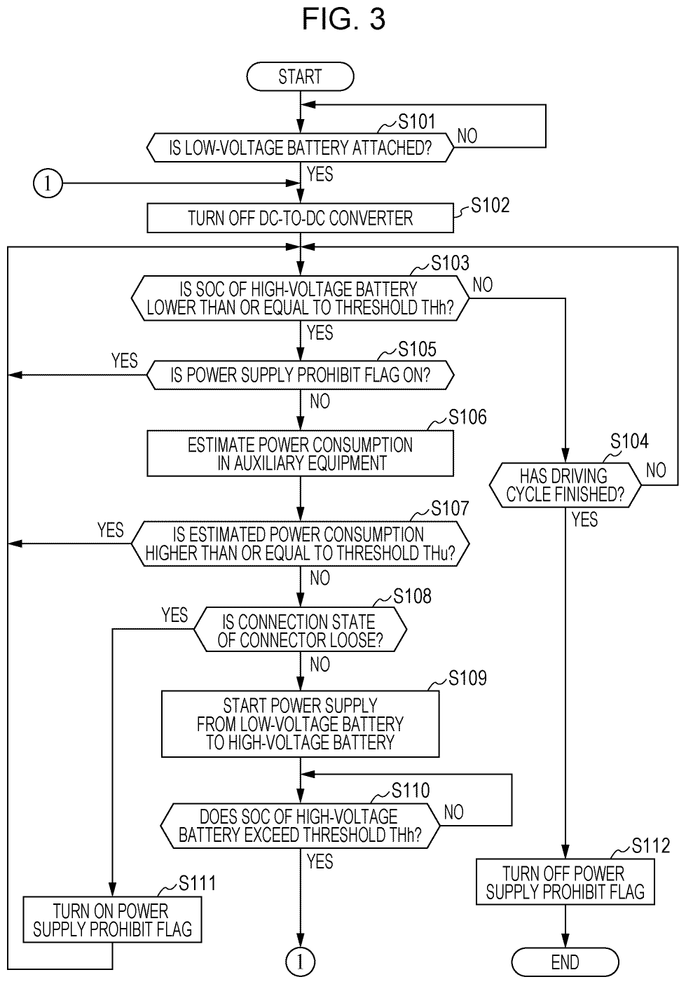

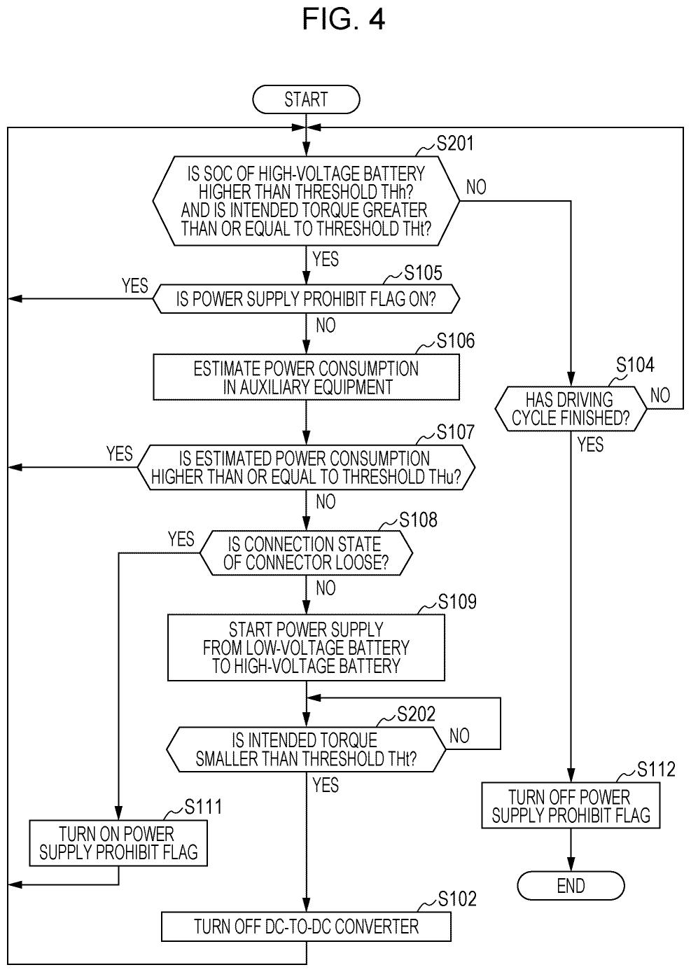

A description will now be given, with reference to the flowcharts of FIGS. 3 and 4, of examples of specific processing procedures executed by the controller 7 to implement power supply control discussed in the above-described embodiment.

FIG. 3 illustrates processing executed by monitoring the SOC of the high-voltage battery 3. FIG. 4 illustrates processing executed by monitoring the intended torque.

In response to the start of the vehicle 1, the controller 7 starts the processing in FIG. 3 and that in FIG. 4 and executes them in parallel.

In the processing in FIG. 3, before the low-voltage battery 10 is attached to the vehicle 1, the controller 7 performs control to turn ON the voltage reducing function of the DC-to-DC converter 6 and to supply power from the high-voltage battery 3 to the auxiliary equipment 5. The voltage reducing function can be made effective by turning ON the voltage reducer 6a and by causing each of the first and second switches SW1 and SW2 to select the second terminal t2.

In FIG. 3, in step S101, the controller 7 determines whether the low-voltage battery 10 is attached to the vehicle 1. This determination may be made in any manner. In one example, the controller 7 may check whether a current flows from the low-voltage battery 10 to the vehicle 1 via the connector 11. In another example, the controller 7 may use a pressure sensitive sensor provided in the connector of the vehicle 1.

If it is determined in step S101 that the low-voltage battery 10 is attached to the vehicle 1, the controller 7 proceeds to step S102 and performs control to turn OFF the DC-to-DC converter 6. This stops power supply from the high-voltage battery 3 to the auxiliary equipment 5 via the voltage reducer 6a, and the power supply source for the auxiliary equipment 5 is switched to the low-voltage battery 10.

After step S102, the controller 7 proceeds to step S103 and determines whether the SOC of the high-voltage battery 3 is lower than or equal to the threshold THh. If it is determined in step S103 that the SOC of the high-voltage battery 3 is higher than the threshold THh, the controller 7 proceeds to step S104 and determines whether the driving cycle has finished. If it is determined in step S104 that the driving cycle has not finished, the controller 7 returns to step S103.

As a result of executing steps S103 and S104, the controller 7 waits until the SOC of the high-voltage battery 3 becomes lower than or equal to the threshold THh or until the driving cycle has finished.

Examples of the end timing of the driving cycle have been discussed above and an explanation thereof will be omitted.

If it is determined in step S103 that the SOC of the high-voltage battery 3 is lower than or equal to the threshold THh, the controller 7 proceeds to step S105 and determines whether a power supply prohibit flag is ON. The power supply prohibit flag is a flag indicating whether power supply from the low-voltage battery 10 to the high-voltage battery 3 is prohibited during the current driving cycle in accordance with whether the connection state of the connector 11 is loose. The initial state of the power supply prohibit flag is OFF, which indicates that power supply from the low-voltage battery 10 to the high-voltage battery 3 is not prohibited. The power supply prohibit flag is turned ON in step S111, which indicates that power supply from the low-voltage battery 10 to the high-voltage battery 3 is prohibited. This will be discussed later.

If it is determined in step S105 that the power supply prohibit flag is not ON, the controller 7 proceeds to step S106 and estimates power consumption in the auxiliary equipment 5. Examples of the approach to estimating the power consumption in the auxiliary equipment 5 have been discussed above and an explanation thereof will be omitted.

After step S106, the controller 7 proceeds to step S107 and determines whether the estimated power consumption is higher than or equal to the threshold THu. If the estimated power consumption is found to be lower than the threshold THU, the controller 7 proceeds to step S108 and determines whether the connection state of the connector 11 is loose.

If it is determined in step S108 that the connection state of the connector 11 is not loose, in other words, if the connector 11 is securely connected, the controller 7 proceeds to step S109 and performs control to start power supply from the low-voltage battery 10 to the high-voltage battery 3. That is, the controller 7 instructs the control circuit 6c to turn ON the voltage boost function of the DC-to-DC converter 6. In response to this instruction, the control circuit 6c turns ON the voltage booster 6b and also causes the first and second switches SW1 and SW2 to select the third terminal t3.

With the above-described operation, if the SOC of the high-voltage battery 3 is reduced to be lower than or equal to the threshold THh, power supply from the low-voltage battery 10 to the high-voltage battery 3 is started on condition that the power consumption in the auxiliary equipment 5 is lower than the threshold THu and that the connector 11 is not loosely connected, but is securely connected.

After step S109, the controller 7 proceeds to step S110 and waits until the SOC of the high-voltage battery 3 exceeds the threshold THh, and when the SOC of the high-voltage battery 3 exceeds the threshold THh, the controller 7 returns to step S102.

In response to the SOC of the high-voltage battery 3 exceeding the threshold THh, power supply from the low-voltage battery 10 to the high-voltage battery 3 started in step S109 is stopped.

If it is determined in step S107 that the estimated power consumption is higher than or equal to the threshold THU, the controller 7 returns to step S103. Even if the SOC Of the high-voltage battery 3 has become lower than or equal to the threshold THh, power supply from the low-voltage battery 10 to the high-voltage battery 3 is not performed if the power consumption in the auxiliary equipment 5 is higher than or equal to the threshold THu.

If it is determined in step S108 that the connection state of the connector 11 is loose, the controller 7 proceeds to step S111 and turns ON the power supply prohibit flag and then returns to step S103.

After the power supply prohibit flag is turned ON, even if the SOC of the high-voltage battery 3 is found to be lower than or equal to the threshold THh in step S103, the controller 7 returns to step S103 since the power supply prohibit flag is found to be ON in step S105. As a result, after it is determined in step S108 that the connection state of the connector 11 is loose, power supply from the low-voltage battery 10 to the high-voltage battery 3 is not performed until the end of the current driving cycle.

If it is determined in step S104 that the driving cycle has finished, the controller 7 proceeds to step S112 and turns OFF the power supply prohibit flag. The controller 7 then completes a series of processing in FIG. 3.

The processing in FIG. 4 will now be described below.

An operation illustrated in FIG. 4 similar to the operation that has been explained with reference to FIG. 3 is designated by like step number and a detailed explanation thereof will be omitted.

In FIG. 4, the controller 7 determines in step S201 whether the SOC of the high-voltage battery 3 is higher than the threshold THh and whether the intended torque is greater than or equal to the threshold THt.

If it is determined in step S201 that the condition that the SOC of the high-voltage battery 3 is higher than the threshold THh and the intended torque is greater than or equal to the threshold THt is not satisfied, the controller 7 proceeds to step S104 and determines whether the driving cycle has finished. If it is determined in step S104 that the driving cycle has not finished, the controller 7 returns to step S201.

As a result of executing steps S201 and S104, the controller 7 waits until the SOC of the high-voltage battery 3 becomes higher than the threshold THh and the intended torque becomes greater than or equal to the threshold THt or until the driving cycle has finished.

If it is determined in step S201 that the SOC of the high-voltage battery 3 is higher than the threshold THh and the intended torque is greater than or equal to the threshold THt, the controller 7 proceeds to step S105 and determines whether the power supply prohibit flag is ON. If the power supply prohibit flag is not ON, the controller 7 proceeds to step S106 and estimates power consumption in the auxiliary equipment 5. The controller 7 then determines in step S107 whether the estimated power consumption is higher than or equal to the threshold THu.

If the estimated power consumption is found to be lower than the threshold THu, the controller 7 proceeds to step S108 and determines whether the connection state of the connector 11 is loose. If it is determined in step S108 that the connection state of the connector 11 is not loose, the controller 7 proceeds to step S109 and performs control to start power supply from the low-voltage battery 10 to the high-voltage battery 3.

In the power supply control operation based on the intended torque, power supply from the low-voltage battery 10 to the high-voltage battery 3 is started on condition that the power consumption in the auxiliary equipment 5 is lower than the threshold THu and that the connector 11 is not loosely connected, but is securely connected.

After step S109, the controller 7 proceeds to step S202 and waits until the intended torque becomes smaller than the threshold THt, and when the intended torque becomes smaller than the threshold THt, the controller 7 turns OFF the DC-to-DC converter 6 in step S102 and returns to step S201.

Power supply from the low-voltage battery 10 to the high-voltage battery 3 started in response to the intended torque becoming greater than or equal to the threshold THt is stopped in response to the intended torque becoming smaller than the threshold THt.

As illustrated in FIG. 4, if it is determined in step S105 that the power supply prohibit flag is ON, the controller 7 returns to step S201. With this operation, even if the intended torque is found to become greater than or equal to the threshold THt in step S201, power supply from the low-voltage battery 10 to the high-voltage battery 3 is not performed until the end of the current driving cycle if the connection state of the connector 11 is found to be loose in step S108.

If it is determined in step S107 that the estimated power consumption in the auxiliary equipment 5 is higher than or equal to the threshold THu, the controller 7 returns to step S201. If it is determined in step S108 that the connection state of the connector 11 is loose, the controller 7 turns ON the power supply prohibit flag in step S111 and then returns to step S201.

With this operation, even when the intended torque becomes greater than or equal to the threshold THt, power supply from the low-voltage battery 10 to the high-voltage battery 3 is not performed if the power consumption in the auxiliary equipment 5 is higher than or equal to the threshold THu or the connection state of the connector 11 is loose.

If it is determined in step S104 that the driving cycle has finished, the controller 7 proceeds to step S112 and turns OFF the power supply prohibit flag. The controller 7 then completes a series of processing in FIG. 4.

For the sake of description, power supply control processing in the embodiment is executed by the single processor by way of example. However, the execution of this processing may be distributed over multiple processors.

The embodiment is not limited to the above-described specific examples and may be implemented as a wide variety of modified examples.

For instance, in the above-described example, the power supply prohibit flag is turned OFF when the current driving cycle has finished, and then, power supply can be started in the next driving cycle. As the condition for canceling the ON state of the power supply prohibit flag, another condition may be employed. For example, when the low-voltage battery 10 is remounted on the vehicle 1, the ON state of the power supply prohibit flag may be canceled.

In the above-described example, the disclosure is applied to a vehicle as a BEV. However, the disclosure is widely applicable to various types of electrified vehicles, such as hybrid EVs (hybrid EVs) and plug-in hybrid EVs (PHEVs). In particular, the disclosure is suitably used for a vehicle that is not equipped with any battery for auxiliary equipment, such as a lead battery, for permanent use.

As described above, a vehicle (vehicle 1) of the embodiment includes a motor (MG 2) provided as a drive source for the wheels, a first battery (high-voltage battery 3) provided as a power supply source for the motor, auxiliary equipment (auxiliary equipment 5), a battery mounting member (battery mounting member 8) that can removably mount a second battery (low-voltage battery 10) thereon, and a voltage booster (voltage booster 6b) that boosts the output voltage of the second battery. The rated output voltage of the second battery is lower than that of the first battery. When the second battery is mounted on the battery mounting member, it is able to supply power to the auxiliary equipment and also to the first battery via the voltage booster. The vehicle also includes one or more processors (hereinafter simply called the processor) (the CPU of the controller 7), and a storage medium (the ROM of the controller 7) that stores a program to be executed by the processor. The program includes one or more commands (hereinafter simply called the command).

The command causes the processor to execute power supply control processing. In the power supply control processing, when a charging rate (SOC) of the first battery becomes lower than or equal to a predetermined value, power consumption in the auxiliary equipment is estimated, and power supply from the second battery to the first battery is started at least on condition that the value of the estimated power consumption is smaller than a threshold.

In the vehicle configured as described above, when the second battery is mounted on the battery mounting member, power supply from the second battery to the auxiliary equipment is made possible and power supply from the second battery to the first battery is also made possible. When power is supplied from the first battery to the auxiliary equipment, the output voltage of the first battery is reduced, which causes the occurrence of conversion loss. Implementing power supply from the second battery to the auxiliary equipment can prevent the occurrence of conversion loss, thereby increasing the efficiency in power supply to the auxiliary equipment.

In the above-described vehicle, when the power consumption in the auxiliary equipment is higher than or equal to the threshold, that is, if intended power for the auxiliary equipment is high, power supply from the second battery to the first battery is not performed. This can prevent the auxiliary equipment from suffering from power shortage and thereby prevent the vehicle from being unable to run.

In the vehicle of the embodiment, which is used as an electrified vehicle including a motor provided as a drive source for the wheels, the use of a power supply system can be improved.

In the vehicle of the embodiment, in the power supply control processing, when the intended torque of the motor becomes greater than or equal to a predetermined value, the power consumption in the auxiliary equipment is estimated, and the power supply from the second battery to the first battery is started at least on condition that the value of the estimated power consumption is smaller than the threshold.

With this configuration, when the output of the motor is predicted to be high, power supply from the second battery to the first battery can be performed.

This can prevent the motor from being short of driving force and thereby prevent the degradation of the acceleration performance of the vehicle.

In the vehicle of the embodiment, in the power supply control processing, when the charging rate of the first battery becomes lower than or equal to the predetermined value, a determination is made regarding whether a connector used for electrically connecting the second battery is loosely connected, and the power supply from the second battery to the first battery is started on condition that the value of the estimated power consumption is smaller than the threshold and that the connector is not loosely connected, but is securely connected.

When the connector is loosely connected, electric arc may occur between the terminal of the second battery and the terminal of the body of the vehicle. In particular, the voltage is boosted when supplying power from the second battery to the first battery, and the occurrence of electric arc may lead to an accident, such as catching fire. In the above-described configuration, when the connector is loosely connected, power supply from the second battery to the first battery is not performed, and the safety is thus improved.

In the vehicle of the embodiment, when a result of the determination, which is made during a certain driving cycle, indicates that the connector is loosely connected, the command causes the processor to execute maintaining processing. In the maintaining processing, a state in which the power supply from the second battery to the first battery is not performed is maintained during this driving cycle.

With this configuration, power is not supplied from the second battery to the first battery until the connector seems ready to be reconnected. After the connector is reconnected, power supply from the second battery to the first battery can be started.

It is thus possible to improve the safety, as well as to extend the drivable distance of the vehicle and to assist the first battery in driving the motor by supplying power from the second battery to the first battery.

The vehicle of the embodiment includes a voltage reducer (voltage reducer 6a) that reduces the output voltage of the first battery. When the second battery is not mounted on the battery mounting member, the command causes the processor to execute power supply/stop processing. In the power supply/stop processing, power supply from the first battery to the auxiliary equipment is performed via the voltage reducer, and the power supply from the first battery to the auxiliary equipment is stopped in response to the second battery being mounted on the battery mounting member.

With this configuration, power supply to the auxiliary equipment can be performed without the second battery, so that the vehicle can run. After the second battery is mounted on the battery mounting member, power supply from the first battery to the auxiliary equipment using the voltage reducer is stopped, thereby preventing the occurrence of conversion loss. That is, the efficiency in power supply to the auxiliary equipment is increased.

The controller 7 illustrated in FIGS. 1 and 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the controller 7. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 1 and 2.

1. A vehicle comprising:
a motor provided as a drive source for a wheel;
a first battery provided as a power supply source for the motor;
auxiliary equipment;
a battery mounting member configured to removably mount a second battery on the battery mounting member, a rated output voltage of the second battery being lower than a rated output voltage of the first battery;
a voltage booster configured to boost an output voltage of the second battery;
at least one processor; and
a storage medium configured to store a program to be executed by the at least one processor, wherein
the second battery is configured to, when the second battery is mounted on the battery mounting member, supply power to the auxiliary equipment and also supply power to the first battery via the voltage booster,
the program includes at least one command that causes the at least one processor to execute power supply control processing, and
in the power supply control processing, when a charging rate of the first battery becomes lower than or equal to a predetermined value,
power consumption in the auxiliary equipment is estimated, and
power supply from the second battery to the first battery is started at least on condition that a value of the estimated power consumption is smaller than a threshold.

2. The vehicle according to claim 1, wherein, in the power supply control processing, when an intended torque of the motor becomes greater than or equal to a predetermined value,
the power consumption in the auxiliary equipment is estimated, and
the power supply from the second battery to the first battery is started at least on condition that the value of the estimated power consumption is smaller than the threshold.

3. The vehicle according to claim 1, wherein, in the power supply control processing, when the charging rate of the first battery becomes lower than or equal to the predetermined value,
a determination is made regarding whether a connector used for electrically connecting the second battery is loosely connected, and
the power supply from the second battery to the first battery is started on condition that the value of the estimated power consumption is smaller than the threshold and that the connector is not loosely connected, but is securely connected.

4. The vehicle according to claim 3, wherein:
when a result of the determination, which is made during a certain driving cycle, indicates that the connector is loosely connected, the at least one command causes the at least one processor to execute maintaining processing; and
in the maintaining processing, a state in which the power supply from the second battery to the first battery is not performed is maintained during the certain driving cycle.

5. The vehicle according to claim 1, further comprising:
a voltage reducer configured to reduce an output voltage of the first battery, wherein
when the second battery is not mounted on the battery mounting member, the at least one command causes the at least one processor to execute power supply/stop processing, and
in the power supply/stop processing,
power supply from the first battery to the auxiliary equipment is performed via the voltage reducer, and
the power supply from the first battery to the auxiliary equipment is stopped in response to the second battery being mounted on the battery mounting member.

6. The vehicle according to claim 2, further comprising:
a voltage reducer configured to reduce an output voltage of the first battery, wherein
when the second battery is not mounted on the battery mounting member, the at least one command causes the at least one processor to execute power supply/stop processing, and
in the power supply/stop processing,
power supply from the first battery to the auxiliary equipment is performed via the voltage reducer, and
the power supply from the first battery to the auxiliary equipment is stopped in response to the second battery being mounted on the battery mounting member.

7. The vehicle according to claim 3, further comprising:
a voltage reducer configured to reduce an output voltage of the first battery, wherein
when the second battery is not mounted on the battery mounting member, the at least one command causes the at least one processor to execute power supply/stop processing, and
in the power supply/stop processing,
power supply from the first battery to the auxiliary equipment is performed via the voltage reducer, and
the power supply from the first battery to the auxiliary equipment is stopped in response to the second battery being mounted on the battery mounting member.

8. The vehicle according to claim 4, further comprising:
a voltage reducer configured to reduce an output voltage of the first battery, wherein
when the second battery is not mounted on the battery mounting member, the at least one command causes the at least one processor to execute power supply/stop processing, and
in the power supply/stop processing,
power supply from the first battery to the auxiliary equipment is performed via the voltage reducer, and
the power supply from the first battery to the auxiliary equipment is stopped in response to the second battery being mounted on the battery mounting member.
